(19) United States
(12) Patent Application Publication
(10) Pub. No.: US 2019/0039369 A1
(43) Pub. Date: Feb. 7, 2019

(54) A PRINTING MACHINE

(71) Applicant: HP INDIGO B.V., Amstelveen (NL)

(72) Inventors: Udi Saad, Ness Ziona (IL); Shahar Tal, Ness Ziona (IL)

(73) Assignee: HP INDIGO B.V., Amstelveen (NL)

(21) Appl. No.: 16/072,988

(22) PCT Filed: Apr. 27, 2016
(86) PCT No.: PCT/EP2016/059417

§ 371 Date: Jul. 26, 2018

(51) Int. Cl. B41F 13/03; B65H 20/16

(52) U.S. Cl. CPC B41F 13/03; B65H 2301/414; B65H 2301/522; B65H 20/16

(57) ABSTRACT

There is disclosed a printing machine (10), including a plurality of rollers (20) defining a web path for transitioning a web of media through the printing machine. Each of the plurality of rollers (20) is provided with a guide collar (60) for locating a belt (40) on the respective roller. The belt follows the web path and releasably connects to the web of media such that when the belt (40) is connected to the web (30) and when the guide collar (60) is rotated around an axis of rotation of the roller, the belt threads the web (30) along the web path.

### BACKGROUND

In a device handling paper, such as a printing machine, it is important to be able to thread a web of media such as paper from a roll of paper through the printing machine.

### BRIEF DESCRIPTION OF THE DRAWINGS

Embodiments are further described hereinafter with reference to the accompanying drawings, in which:

FIG. 1 shows an example of a printing machine with a web of paper being threaded along a web path defined by a series of rollers;

FIG. 2 shows an example of a printing machine with the web of paper transitioning along the web path defined by a series of rollers;

FIG. 3 shows an example of a roller and a guide collar; and

FIG. 4 shows an example of a roller, guide collar and belt.

### DETAILED DESCRIPTION

Web-fed printing machines and printing presses provide a variety of print solutions for industry. Web-fed printers and presses are reliable and stable machines. Web-fed printers and presses have three main parts. A feed-winder for feeding media such as paper to the printer or press; a printing platform which may be an off-set printing platform or a digital printing platform; and a collect-winder for collecting the printed web. In order to maintain the web of media under tension, web-fed printing machines have a plurality of rollers for transitioning the web through the printer. Some printers and presses have tens of rollers. Some rollers are static and some rollers move to contribute to maintaining the web under tension.

Often the web path of the web-fed printer or press is complex due to the high number of rollers and the complex path generated by incorporating a large number of rollers while trying to minimise the overall size of the printer or press. When the web is used up and needs to be replaced by a new web or when the operator needs to change the type of web for a new type of web, the complex web path can cause difficulties in threading a web through the web path.

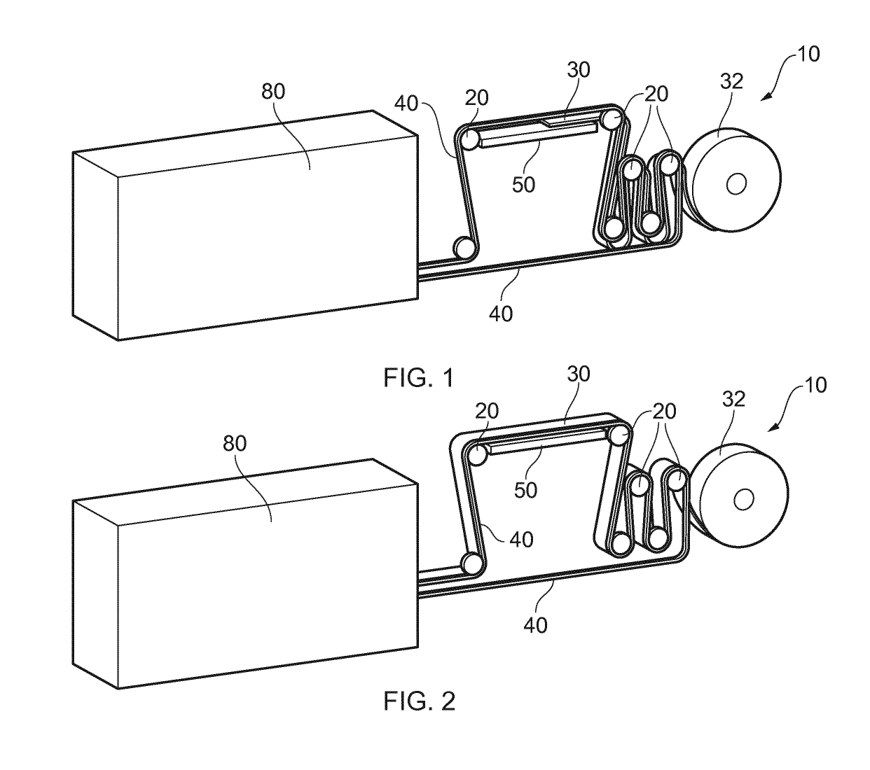

FIGS. 1 and 2 show a printing machine 10 including a plurality of rollers 20 defining a web path for transitioning a web of media 30 from a feed winder 32 (such as a roll of paper) through the printing machine 10. The rollers 20 transition the web 30 from the feed-winder 32 to a collection winder (not shown) via a printing platform (also not shown).

The rollers 20 define a complex web path for the web 30. A number of rollers may be static rollers while others may be freely rotatable, and others may be driven rollers. The rollers work together to keep the web under sufficient tension to enable precise and consistent printing of the web.

FIG. 1 shows a web of paper 30 being threaded through the rollers via a connector towards a working table 50. The working table 50 provides a working surface for replacing or repairing the web 30. The working table 50 may be provided with a number of clamps for clamping the web of media 30 to the working table 50.

The printing machine includes a belt 40. The belt is configured to follow the web path as shown in FIGS. 1 and 2. The belt is located on each respective roller in a continuous loop.

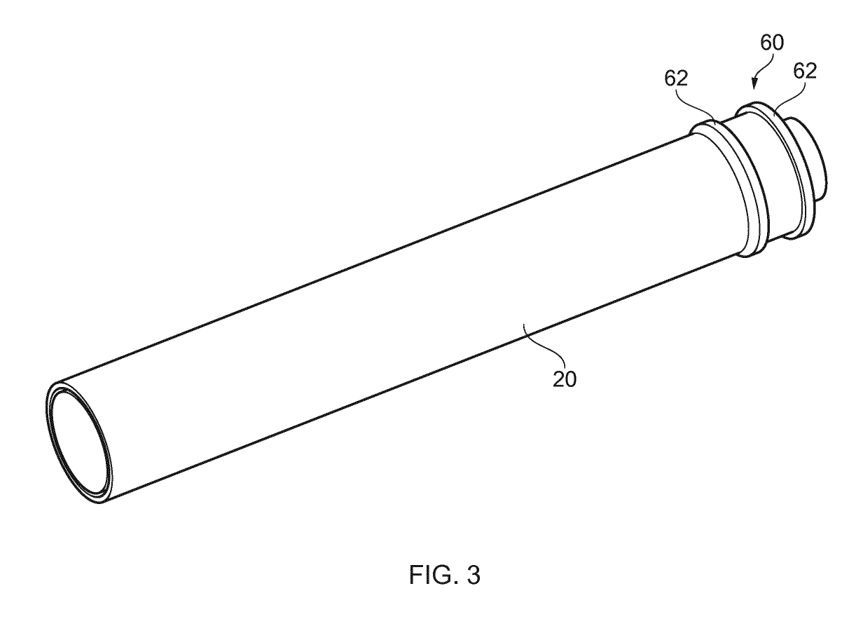

FIG. 3 shows an example of a roller 20. The rollers 20 are provided with a guide collar 60 for locating the belt 40 on the respective roller 20 so that the belt 40 follows the web path. The belt 40 is configured for releasable connection to the web of media 30. When the belt 40 is connected to the web 30 and the guide collar 60 is rotated around an axis of rotation of the roller 20, the belt 40 threads the web 30 along the web path in the printing machine 10.

The guide collar 60 is configured to switchably engage and disengage with the roller 20. When the guide collar 60 is engaged with the roller 20, rotation of the roller 20 causes active rotation of the guide collar 60. If the web of media 30 is connected to the belt 40, active rotation of the guide collar 60 will thread the web of media 30 through the web path and enable the user to either replace or reconnect the web 30 in the printing machine 10. When the guide collar 60 is disengaged from the roller 20, rotation of the roller 20 does not cause active rotation of the guide collar 60 and the belt 40 remains stationary while the rollers 20 rotate.

In one example, the guide collar 60 is mechanically engageable with the roller 20. A simple mechanical switch is used to engage the guide collar 60 with the roller 20 such that rotation of the roller 20 causes active rotation of the guide collar 60.

In another example, the guide collar 60 is electromagnetically engageable with the roller 20. A simple electromagnetic circuit is embedded in the guide collar 60 and may be switched on to engage the guide collar 60 with the roller 20 such that rotation of the roller 20 causes active rotation of the guide collar 60.

Rotating a disengaged guide collar 60 relative to the roller 20 also actively transitions the belt 40 through the web path such that a web 30 connected to the belt 40 is threaded through the web path.

The guide collar 60 is located at one end of the roller 20. Locating the guide collar 60 at one end of the roller 20 reduces the risk of the guide collar 60 coming into the direct path of the web of media 30 during printing. The web of media 30 may be quite fragile so avoiding contact between the web of media 30 and the guide collar 60 is important.

In one example, the guide collar 60 is located at a fixed location at one end of the roller 20 so as to limit interference of the guide collar 60 with a web of media 30.

The guide collar 60 is substantially tube shaped and fits coaxially around the outer surface of the roller 20. The guide collar 60 has an inner tubular wall with an inner diameter of the tubular wall being substantially similar to the outer diameter of the roller 20 so that the guide collar 60 is rotatable relative to the roller 20. The sizing of the inner tubular wall may be chosen to provide a snug fit between the guide collar 60 and the roller 20.

In one example, the inner tubular wall is formed from a low friction material such as PTFE or the like. This smooth inner wall facilitates rotation of the guide collar 60 around the roller 20 to aid the user in rotating the guide collar 60 relative to the respective roller 20. This is particularly beneficial in printing machines having a high number of rollers 20 defining either a long or complex web path.

The guide collar 60 is further provided with flanges 62 at both ends of the guide collar 60. The flanges 62 are upstanding from the collar 60 and are located and shaped to retain the belt in the guide collar 60. Preventing the belt 40 from skewing on the guide collar 60 is important as this reduces the risk of the belt 40 interfering with the web of media 30 on the roller 20.

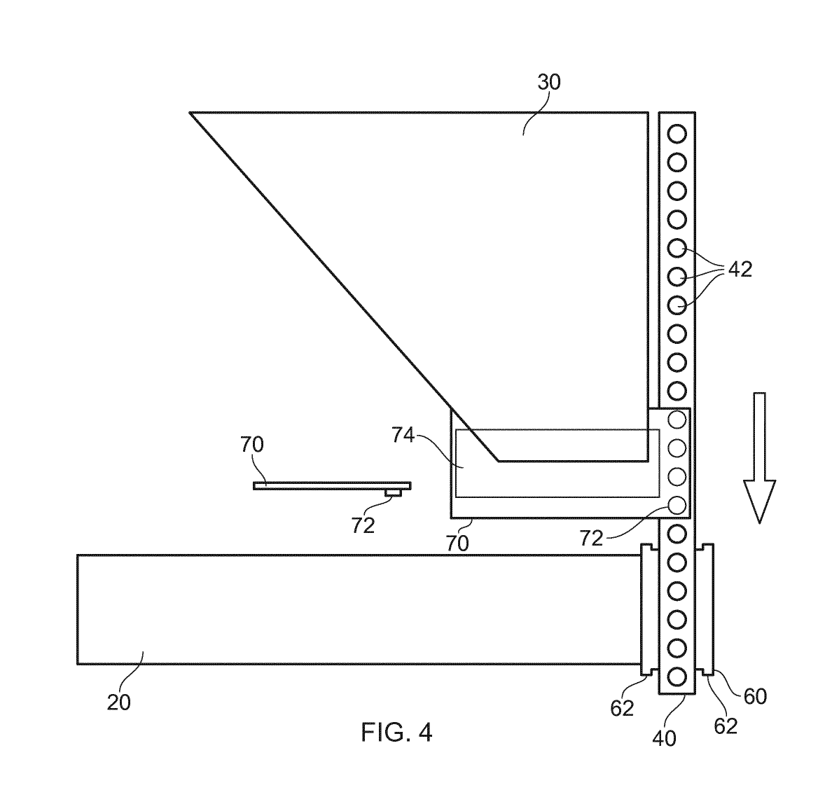

The belt 40 is shown in more detail in FIG. 4. The belt 40 may be provided with connecting elements 42 to provide easy attachment of the web of media 30 along the length of the belt 40. The connecting elements 42 enable connection of the web 30 to the belt 40. Only one connecting element 42 need be provided since the guide collar 60 may be rotated through the web path so that the connecting element 42 arrives at the required location. In an improved system, connecting elements 42 are provided along the length of the belt 40.

The web 30 may be connected directly to the connecting element 72. However, it may be preferably to provide a web connecting arm 70 for connecting the web 30 to the belt 40. The web connecting arm 70 may be adapted to accommodate different types of webs 30. In FIG. 3, the web connecting arm 70 is provided with a cooperating connecting element 72 to allow the web connecting arm 70 to be easily connected to the belt 40. An alternative approach is to use an adhesive strip 74 to connect the web connecting arm 70 to the web 30. A benefit of using a web connecting arm 70 rather than directly connecting the web 30 to the belt 40 is that the connector protects the web 30 and prevents the web 30 from being skewed as it is threaded through the web path.

In an example the connecting element 42 is a hook fastener and the cooperating connecting element 72 is a loop fastener. In another example the connecting element 42 is a loop fastener and the cooperating connecting element 72 is a hook fastener. In another example, two hook fasteners may be used. In another example, the connecting element 42 and the cooperating element may be snap fasteners.

In another example, at least one of the guide collars 60 is formed integrally with its respective roller 20. Integrally forming the roller 20 with the guide collar 60 may simplify the manufacturing of the rollers 20 and guide collars 60.

A benefit of the printing machine 10 is that the belt 40 enables the user to rapidly and accurately thread a web of media 30 through the web path defined by the rollers 20. The user may need to thread the web 30 through the printing machine 10 in a variety of different situations including when the web 30 tears or is damaged, or if the user identifies a manufacturing problem with a particular roll of paper 32 for example. Furthermore, the user may need to re-thread a web 30 in the instance of a paper jam in the printing machine 10 or due to a mechanical problem. Re-threading a web 30 through a complex set of rollers 20 is challenging and any mistakes in threading the web 30 along the web path may lead to excess down time or serious damage to the printing machine 10. Using the belt 40 enables the user to accurately and quickly thread the web 30 through even the most complex web paths.

The user can thread the web through the rollers using the belt. The web is pulled by the belt towards the working table 50. The working table 50 provides sufficient space for the user to reconnect the web to a collection winder.

It will be clear to a person skilled in the art that features described in relation to any of the embodiments described above can be applicable interchangeably between the different embodiments. The embodiments described above are examples to illustrate various features of the invention

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A printing machine comprising:
a plurality of rollers defining a web path for transitioning a web of media through the printing machine, wherein each of the plurality of rollers is provided with a guide collar for locating a belt on the respective roller, the belt to follow the web path, and releasably connect to the web of media such that when the belt is connected to the web and when the guide collar is rotated around an axis of rotation of the roller, the belt threads the web along the web path.

2. A printing machine according to claim 1, wherein the guide collar switchably engages and disengages with the roller such that when the guide collar is engaged with the roller, rotation of the roller causes active rotation of the guide collar and when the guide collar is disengaged with the roller, rotation of the roller does not cause active rotation of the guide collar.

3. A printing machine according to claim 1, wherein the guide collar is mechanically or electromagnetically engageable with the roller.

4. A printing machine according to claim 1, wherein the guide collar is located at one end of the roller.

5. A printing machine according to claim 1, wherein the guide collar is located at a fixed location at one end of the roller so as to limit interference of the guide collar with a web of media.

6. A printing machine according to claim 1, wherein the guide collar is tube shaped, the guide collar having an inner tubular wall with an inner diameter of the tubular wall being substantially the same as the outer diameter of the roller so that the guide collar is rotatable relative to the roller.

7. A printing machine according to claim 6, wherein the inner tubular wall is formed from a low friction material.

8. A printing machine according to claim 1, wherein the guide collar is further provided with a flange at a first and a flange at a second end of the guide collar, to retain the belt in the guide collar.

9. A printing machine according to claim 1, further comprising a web connecting arm.

10. A printing machine according to claim 9, the web connecting arm being provided with at least one cooperating connecting element for cooperating with the connecting elements provided on the belt.

11. A printing machine according to claim 10, the at least one connecting element is a hook or a loop fastener and the at least one cooperating connecting element is a loop or a hook fastener.

12. A printing machine according to claim 10, the at least one connecting element is a female snap fastener and the at least one cooperating connecting element is a male snap fastener.

13. A printing machine according to claim 10, the web connecting arm being provided with an adhesive for temporarily adhering to the belt.

14. A printing machine according to claim 1, wherein at least one of the guide collars is formed integrally with its respective roller.
